(19) United States
(12) Patent Application Publication
(10) Pub. No.: US 2008/0222894 A1
(43) Pub. Date: Sep. 18, 2008

(54) Method and device to cut aluminum foil

(76) Inventors: Moran Borenslein, Givatyim (IL); Maor Gross, Givatyim (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/716,972

(22) Filed: Mar. 13, 2007

(51) Int. Cl. B26B 19/02

(52) U.S. Cl. 30/43.92

(57) ABSTRACT

A cutting machine to cut aluminum foil to pre-set and adjustable lengths. An embodiment for a manually operated machine. An embodiment to pre-determine the length and number of aluminum foil pieces whereupon that number of pieces is automatically prepared. An embodiment also to automatically fold the foil around an object like strands of hair.

### FIELD OF THE INVENTION

This invention is in the field of cutting machines and in particular that to cut rolls of aluminum foil to pre-set lengths for use for example when coloring hair.

### BACKGROUND OF THE INVENTION

It is well known in the hairdressing trade and also by the public at large that many people, usually ladies, wish to change the color of their hair. Some people wish to dye all their hair, but there are many, particularly those of the younger generation, who wish to have special effects. These could be streaky, chunky, stripes or even in artistic forms of drawings. In order to ensure complete separation of color between the various locks or strands of hair it is common practice to dye the differing locks by painting the dye on the hair and then wrap them in aluminum foil.

The same practice is also used when wishing to lighten the color of the hair and have differing effects. In this case also, the locks of hair are separated out into different stresses, laid on the aluminum foil, dye or bleach is applied to the individual locks, and then the foil is wrapped around the hair.

This practice of wrapping the hair in foil has been found to have at least two benefits. The first is that the bleaching or the dye takes permanent effect faster. This is probably due to the body-heat being transferred and conserved by the aluminum foil which is wrapped around these stresses of hair.

The other is that it physically prevents the dye from coloring the adjacent locks or strands of hair that one does not wish to color. This second effect is even more important when the customer wishes not only to have a streak effect in his natural color but wishes to display his hair in a two-color display.

Then this process may have to be done twice, as it is necessary to protect the rest of the hair as each color dye is applied.

As previously mentioned it has also been found that the dye sets or takes permanent effect faster when heat is applied. In some salons its has been the practice to use a hand-held blow-dryer, but this practice has, on occasion, led to negative and harmful results, including burning of the hair and skin due to a chemical reaction between the heat being applied and the chemicals in the dye. Using aluminum foil uses body heat of the person being treated which is enough heat to help the setting process of the dye on the hair.

Another method to color the hair is by wrapping colored aluminum foil around the individual strands of hair. This helps to set the dye onto the hair.

It is well known in the art, especially when using liquid dyes, that the foil has to be applied immediately after the dye has been applied. This is very difficult, especially when applying dye to ones own hair. Also in a professional salon, the stylist wishes to apply the aluminum foil quickly, but is faced with the problem of having both hands occupied, one holding the lock of hair separate and the other applying the dye. The stylist now has the additional difficulty of trying to tear of a piece of foil and wrap it around the stress or lock of hair. A customer may have a hundred or more aluminum wrapped locks of hair at one sitting. There are not enough hands to complete this task in a reasonable amount of time.

Other methods have been tried to circumvent this difficulty, but with varying measures of success. Some of these include having the foil being packed in pre-cut lengths, but this is not desirable as the length of hair being dyed is variable and hence the foil is required to be of varying lengths. Also, this method is difficult to remove the cut sheets one at a time with one hand.

As this process of dyeing hair can involve many strips of aluminum foil in order to color one head of hair, the amount of time required in preparation of these foil strips, for each client, is great.

This invention will enable the user to choose the length of foil strips, the number of strips and cut them automatically. It will save a considerable amount of time for the stylist and for the client, as these strips cannot be prepared except shortly before the dying process. Hair stylists usually seek ways to work more proficiently and serve more clients in the work day.

In another embodiment of this invention it could allow hair coloring to be done by the individual by himself without the need for another to do the dying for him. This device could be used at home.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute part of this specification. The drawings illustrate various embodiments of the invention and, together with the description serve to explain the principles and operations of the invention

The invention comprises a dispenser of hairdresser's dyeing foil. The dispenser could accommodate different widths of foil even though the width used in the hairstyle industry is currently a standard width. The dispenser has a place to hold the roll of foil and allow it to turn on its longitudinal axis when the dispenser pulls the said foil for cutting. The user presses a number-pad to instruct the machine to cut the foil strip to a particular length. Standard lengths could have code numbers or letters for example “A” could be pre-programmed to cut ten centimeter lengths and “B” 15 centimeter lengths and so on. Another number-pad or a second mode on the same number-pad could be used to choose the number of strips of foil of the chosen length. The start button would start the cutting process that would include pulling the programmed amount of foil to be pulled off the roll and then the foil is cut to size. The cut pieces would lie one on top of the other ready to be taken by the hair stylist.

The foil could be pulled off the roll by two rollers positioned parallel to the roll of foil, touching each other along their length where the top roller would turn clockwise when looking from the right of the device. The bottom roller would roll anti-clockwise. An electronic eye or laser beam could be used to measure the length of foil and when the required length has been pulled from the roll, the foil is cut for example by a guillotine device. The length measurement could be done by the said rollers whereby each complete turn of the roller would represent a fixed length. After a given number of turns a pulse would be sent to the cutting device to cut the foil. After the programmed number of cuts the cutting device and rollers would switch off as that program of cut foil would be complete.

A tray could be positioned to collect the cut strips of foil. The machine would be placed close to the user so that he could program the cutting details, operate the device and conveniently remove cut pieces when needed.

The above described machine could also be operated partially or entirely manually. That is to say a ratchet lever could pull aluminum foil off the roll onto a tray with measurements of length printed thereon. When the required length had been reached the manually operated guillotine would be used to cut the foil. The obvious disadvantage of this manual embodiment is the time needed to attend to this task bearing in mind one hair dying job can use more than a hundred pieces of foil.

The usual actions of the stylist once he has a strip of foil of the correct size is to hold the desired amount of hair along the length of the foil having cupped the width of the foil making a long “U” shape. Then while holding the foil with the hair resting along its cupped length in one hand he uses his other hand to paint on the die with the other hand. Finally, he closes and crimps the width of the foil around the hair to hold it in place while the die sets on the hair. As mentioned above the setting process is assisted by the heat of the body heating the die inside the closed foil.

Another embodiment of this invention could be to dispense the foil from a roll and feed it forward over a flexible surface. The hair could then be laid on the said foil, painted manually or by the machine with the required dye and the flexible surface would then close around the hair, wrapping it into the strip of foil.

The invention could be of a mechanical, manual mechanism. A modification of this could be that it has an electrically-powered mechanism. This could be either mains-operated, or powered by a battery.

A modification of the feed method could be that the wheel on which the foil is loaded is connected to an electrical motor. By the stylist pressing a button on the device a motor causes the roll of foil to rotate thereby releasing the foil. Another modification could be that the speed of the said motor could be variably controlled, this being done by a pistol-type trigger button whereby the stylist squeezing harder on the said trigger button the speed of the motor increases. Releasing the said trigger button completely will stop the motor rotating.

A further modification could be to allow the motor direction to be reversible, thus allowing the stylist to take up any slack in the foil should too much have been released.

The invention is designed so as to cut the aluminum foil at any desired length. The cutting mechanism is also controlled by the stylist. This mechanism could be of a mechanical type. A modification of this could be that the cutting mechanism is electrically operated.

The said invention could also be modified to automatically seal the foil around the lock. There are a number of methods by which this could be done. One method could be by crimping every few centimeters. Another possibility could be by dropping an elastic band, which is also loaded, at the flexible end of the dispenser. Another possibility could be that the elastic bands are within a magazine, situated over the end of the dispenser, and every few centimeters the elastic band is released and stretched around the foil. Another possibility could be that a wire-type staple is released and stapled around the foil every few centimeters. The control of the sealing process, with all of the different possibilities of sealing, could be manually controlled, through the stylist pressing an additional button on the dispenser. The sealing could also take place automatically after every few centimeters. A further modification of this invention could be to allow the stylist the possibility of the choice of either manually sealing or automatically sealing, with the added possibility of a manual override.

An object of this invention is to cut aluminum foil at desired lengths.

Another object of this invention is to be able to choose the number of lengths to be cut.

Another object of this invention is to program the cutting machine with the information of length and quantity of pieces so that it carries out the programmed task automatically.

Another object of this invention is to wrap the foil around the individual locks of hair.

Another object of this invention is to seal the foil after it has been wrapped around the locks of hair.

A further object of this invention is to enable the device to seal the foil at automatic pre-set intervals, the intervals can be controlled by the stylist manually or electronically.

A further object of this device is to enable the feed of the foil to be motorized.

A further object of this device is to enable the speed of the feed to be controllable by the stylist.

A further object of this device is to enable reversal of the direction of the feed motor, to shorten the length of foil extracted.

### BRIEF DESCRIPTION OF DRAWINGS

The accompanying drawings, which are incorporated in and form a part of this specification, illustrate embodiments of the invention and, together with the description, serve to explain, by way of example only, the principles of the invention:

FIG. 1 shows a drawing of the foil cutting machine.

FIG. 2 shows the roll of foil and the driving rollers.

FIG. 3 shows a schematic side view of the hair gripping machine.

FIG. 4 shows a schematic plan view of the hair gripping machine.

### DESCRIPTION OF PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

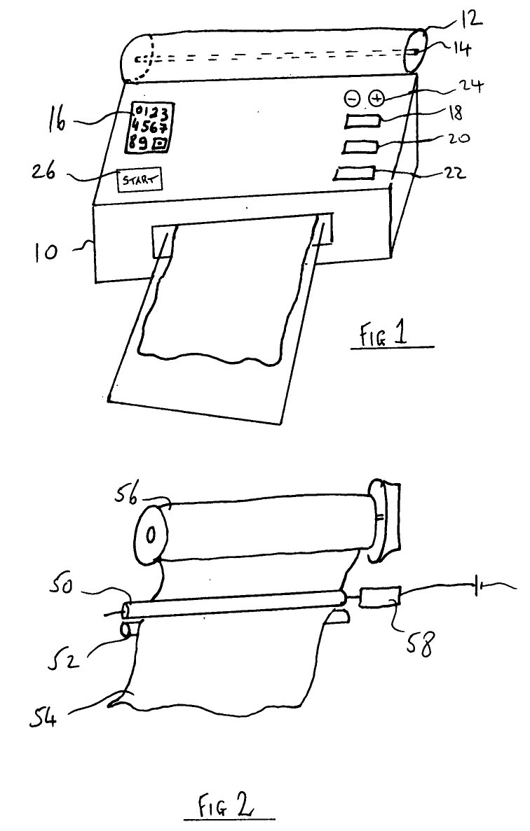

FIG. 1 shows a foil cutting machine 10 with a foil roll holder 12 towards the back of the machine 10. This could be a “U” shaped holder or a have a rod 14 passing through the hollow roll to hold the foil roll along its length thereby reducing friction when it turns.

Number-pad 16 is for programming the functions of the machine 10 for example the length of the foil strips and the number of those strips to be cut. This could be programmed using the mode buttons for example the length using button 18 and the number of lengths using button 20. The input information could be displayed on a screen 22. The speed of the feed and cutting process could be increased and decreased using the plus and minus buttons 24. Once the factors have been entered the user would press the start button 26 to start the machine according to the programmed information. The start button could be of the toggle kind and could be pressed again to stop the machine if it were necessary before the end of the programmed run of cutting. At the end of the programmed run the machine would automatically stop working.

FIG. 2 shows the rollers 50 and 52 that pull the aluminum sheet 54 off the roll of aluminum foil 56 and direct it toward the cutting device. The lower roller 52 could be free to roll and not be motorized. Alternatively it could be motorized to reduce strain on the aluminum sheet 54 as it passes through the rollers. If motorized the two rollers 50 and 52 would turn in opposing directions in order to ease the pull of the aluminum off the roll 56. If roller 52 were not motorized the upper roller 50 would have to press with pressure against the lower roller 52 in order to pull the foil off the roll 56.

The motor 58 could be driven by mains or battery electricity 60. The motor 58, the top roller 50 and the foil cutting device could be connected to the length programmer FIG. 1 18 of the machine FIG. 1 10 so that when the roller has turned a certain number of turns which is equivalent to a length of foil passing through, then the cutting device would cut the foil. Alternately an electronic eye or laser beam could be connected to the cutting device and be used for the length measurement and giving the electrical impulse to the cutting device to cut.

The cutting device and the motor 58 could be connected to a counter so that when the required number of foil sheets had been cut, the motor would stop feeding foil and the cutter would stop cutting.

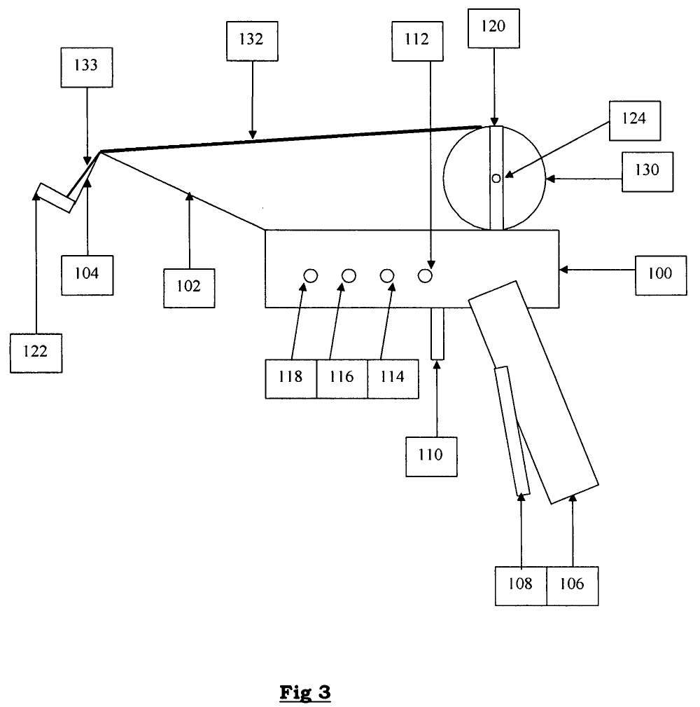

FIG. 3 shows a side view of the embodiment of the invention that assists gripping the aluminum around the hair. The embodiment comprises a number of elements, which could be either mechanical or electrical or a combination of both.

The roll of hairdresser's foil 130 rests on the horizontal axle 124 that is part of the foil holder 120.

The axle 124 could be connected via a belt within the foil holder 120 to an electric motor.

The foil is unrolled from the roll 130 towards the front of the device and passes over the tapering and folding carrier 132 which is narrower than the width of the foil 130.

The tapering and folding carrier 132 is supported by the tapering and folding carrier arm 102.

At the end of the tapering and folding carrier 132 on the side away from the roll of foil 130 is an oval elongated ring slot 104.

A cutter 133 is placed on the oval elongated ring slot 104.

The sealing device 122 sits below the oval elongated ring slot 104.

The tress of hair passes through the oval elongated ring slot 104 which has an open slot to one side—in the shape of the letter U placed on its side in order to allow the tress of hair to be placed within the oval ring 104 from the top of the tress.

The device is passed in a longitudinal direction with respect to the section of hair over the section of hair. The device is held in one hand of the stylist the stylist's other hand holds and guides the tress, holding the end on the foil over the section of hair. The stylist holds the device by the handle 106.

As the invention is moving along the section of hair the foil is released from the roll 130 and passes along the tapering and folding carrier 132. As it passes along the tapering and folding carrier 132 the foil 130 is shaped into a “C” shape, without tearing. The curved foil then encloses the strand of hair at a point close to the oval ring 104, between the oval ring 104 and the body of the device 100. On the side away from the oval ring 104 the curving of the foil 133 is completed to form a hollow tube, which within its center is to be found the tress of hair. The foil can then be sealed by the sealing device 122. The sealing device could include a cartridge of staples, wire ties, elastic or some other such material in order to ensure better sealing.

When the invention has reached the desired point on the hair the foil, which is already wrapped around the section of hair is separated from the roll 130 on the invention by the cutter 133. The cutter can be operated and controlled by the control button 112, or by the trigger 110, the controls having been set by the stylist.

If the feed of the roll is electrically controlled, then the motor speed is controlled by how hard the stylist squeezes the trigger 108.

Should it be desired to reverse the direction of the motor this could be controlled by switch 118.

The options of manual sealing, automatic sealing, or the various combinations, with or without manual override can be controlled by switches 114 and 116.

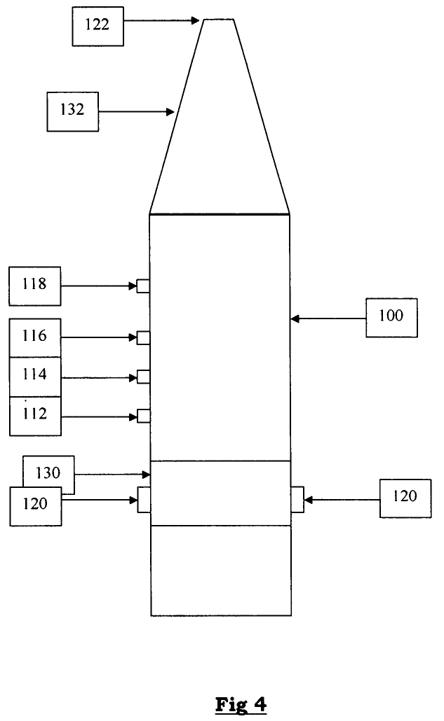

FIG. 4 shows the same embodiment of this invention as is described in FIG. 3 from the plan view. The main body of this invention 100 supports the foil roll holder 120 that holds the roll of foil 130. In the embodiment that is electrically operated the button 112 operates the cutting blade, button 114 operates the sealing, button 116 operates the manual override and button 118 operates the reverse direction option.

The taper and folding carrier 132 end with the sealing device 122.

1. A method and device for cutting aluminum foil comprising:
a) a holder to hold a roll of aluminum foil,
b) a means to pull a length of the said foil from the said roll,
c) a means to measure the said length of foil, and
c) a means to cut the said foil at the desired length, whereby the user can cut pieces of aluminum foil at constant lengths.

2. A method and device for cutting aluminum foil comprising:
a) a holder to hold a roll of aluminum foil,
b) a means to pull a length of the said foil from the said roll,
c) a means to measure the said length of foil,
c) a means to cut the said foil at the desired length,
d) a programmable memory chip to accept instruction of length of foil pieces and number of such pieces,
e) an electrical connection between the said chip, the said means to pull a programmed length of foil from the said roll of aluminum foil, the said means to cut the said foil at the said programmed length and the means to stop the said pulling of foil and said cutting lengths of foil when the programmed number of foil pieces have been cut,
whereby strands of hair can be laid along the length of the said cut aluminum foil ready for dying and thereafter be folded and closed around the said hair along its length to enable the die to set in the said hair.

3. A method and device as claimed in claim 1 wherein the said device is operated at least partly manually.

4. A method and device as claimed in claim 2 wherein the said device is operated at least partly manually.

5. A method and device as claimed in claim 1 wherein the said device is operated at least partly electronically.

6. A method and device as claimed in claim 2 wherein the said device is operated at least partly electronically.

7. A method and device as claimed in claim 2 further comprising a number-pad to program the said chip with the length of foil pieces required.

8. A method and device as claimed in claim 2 further comprising a number-pad to program the said chip with the number of foil pieces required.

9. A method and device as claimed in claim 1 wherein the means to pull a length of the said foil from the said roll is with the aid of at least a pair of manually operated rollers touching tangentially along their length and between which the said foil is pulled when the rollers are rolled.

10. A method and device as claimed in claim 2 wherein the means to pull a length of the said foil from the said roll is with the aid of at least a pair of electronically operated rollers touching along their length and between which the said foil is pulled when the rollers are rolled.

11. A method and device as claimed in claim 1 wherein the said means to pull a length of the said foil from the said roll is with the aid of a gripping device and a ratcheted handle whereby the back and forth movement of the said handle, grips the said foil, pulls an amount off the said roll releases the said grip and moves back to a position to repeat the action.

12. A method and device as claimed in claim 1 wherein the said means to measure the said lengths of foil is with the aid of markings on a tray on which the said foil rests after it has been pulled off the said roll.

13. A method and device as claimed in claim 1 wherein the said means to cut the said foil is with the aid of a blade.

14. A method and device as claimed in claim 1 wherein the said means to cut the said foil is with the aid of a serrated edge.

15. A method and device for cutting aluminum comprising a holder to hold a roll of aluminum foil, a means to pull a length of the said foil off the said roll, a means to roll the said foil around its longitudinal axis, a means to keep closed the said rolled foil and a cutting blade to cut the said foil at the desired length, whereby strands of hair can be laid along the length of the said cut aluminum foil ready for dying and thereafter folded and closed around the said hair along its length to enable the said die to set in the said hair.

16. A method and device as claimed in claim 15 whereby the said foil is held closed with elastic bands.

17. A method and device as claimed in claim 15 whereby the said foil is held closed with clips.
